(19) United States
(12) Patent Application Publication
(10) Pub. No.: US 2026/0357860 A1
(43) Pub. Date: Nov. 12, 2026

(54) COVER DEVICE AND ELECTROMECHANICAL BRAKE SYSTEM INCLUDING THE SAME

(71) Applicant: HYUNDAI MOBIS CO., LTD., Seoul (KR)

(72) Inventors: Sang Pil BOO, Yongin-si (KR); Choong Sik SHIN, Yongin-si (KR); Sehoon AN, Yongin-si (KR); Keun Mo PARK, Yongin-si (KR)

(73) Assignee: HYUNDAI MOBIS CO., LTD., Seoul (KR)

(21) Appl. No.: 19/556,477

(22) Filed: Mar. 4, 2026

(30) Foreign Application Priority Data
May 12, 2025 (KR) 10-2025-0061076

(51) Int. Cl. F16D 65/00; F16D 55/226; F16D 55/00; F16D 121/24

(52) U.S. Cl. CPC F16D 65/0081; F16D 55/226; F16D 65/0031; F16D 2055/0037; F16D 2121/24

(57) ABSTRACT

Disclosed is a cover device, including: a cover body configured to cover and protect an external appearance of a caliper assembly; and a coupling portion configured to couple the cover body to a caliper body, and the cover body may include: a first cover member formed to cover an outer circumferential surface of the caliper assembly; and a second cover member formed to cover a front surface of the caliper assembly and connected to the first cover member, and the cover device may be mounted in an electromechanical brake system.

### CROSS REFERENCE TO RELATED APPLICATION

The present application claims priority to Korea Patent Application No. 10-2025-0061076, filed May 12, 2025, the entire contents of which is incorporated herein for all purposes by this reference.

### FIELD

The present disclosure relates to a cover device and an electromechanical brake system including the same, more particularly, to a cover device configured to protect and cover a caliper assembly for putting a brake on a transportation means such as an automobile and an electromechanical brake system including the same.

### BACKGROUND

An electro-mechanical brake (EMB) is a brake configured to put a brake on a vehicle by using a mechanical operation principle and an actuator driven with an electric motor unlike the conventional hydraulic disk brake. The EMB system generates a braking force by operating a motor through conversion of a force of stepping on a brake pedal by a driver into an electric signal. Such an EMB system has a fast response speed, and is capable of precisely and independently controlling each wheel, and thus, is a structure with an improved braking safety performance. In addition, the EMB system has an environmentally-friendly structure which helps in improving fuel efficiency without generation of a brake oil waste.

A cover mounted in the conventional hydraulic brake is attached to only a front surface of a caliper, and ends up serving as a naming plate. Therefore, in order to improve the role of the cover, a device mounted in the electromechanical brake system and configured to cover the entire surface of the caliper is needed.

### SUMMARY

The present disclosure is conceived to solve the above-described problem, and an object of the present disclosure is to provide a cover device having a unique styling appearance of the electromechanical brake, securing fixability with respect to external vibration, allowing easy attachment and detachment, and configured to easily dissipate heat generated at the time of braking, and an electromechanical brake system including the same, by mounting a cover device in the caliper assembly of the electromechanical brake.

The technical problem to be achieved by the present disclosure is not limited to the above-mentioned technical problem, and other technical problems that are not mentioned will be clearly understood by ordinary-skilled persons in the art to which the present disclosure pertains from the following description.

One embodiment is a cover body formed to cover and protect an external appearance of a caliper assembly; and a coupling portion configured to couple the cover body to a caliper body, and the cover body may include: a first cover member formed to cover an outer circumferential surface of the caliper assembly; and a second cover member formed to cover a front surface of the caliper assembly and connected to the first cover member, and the cover device may be mounted in an electromechanical brake system.

According to an embodiment, the cover body may further include: a recess formed recessed from the first cover member to be in contact with a bridge portion of the caliper body and having a through hole; a fixing portion recessed from the first cover member toward a finger portion of the caliper body and coming into close contact with an outer side surface of the finger portion; and a protrusion protruding from the second cover member toward the caliper body and inserted into an insertion groove positioned at a center of the finger portion.

According to an embodiment, the coupling portion may include: a coupling hole dug on the bridge portion; and a coupling element configured to pass through the through hole, seated on the recess and coupled to the coupling hole, and each of the recess and the coupling portion may be provided one or more in number, and the recess may be inserted between the coupling hole and the coupling element so that the cover body is fixed to the caliper body.

According to an embodiment, a guide configured to guide the coupling element and formed to be communicated with the coupling hole may be configured in the bridge portion.

According to an embodiment, the fixing portion and the protrusion may be configured to fix the cover body to the caliper body so that a movement of the cover body by external vibration is reduced.

According to an embodiment, the cover body may further include: a third cover member configured to cover a side surface of the caliper assembly, refracted and extending from both sides of the second cover member, and connected to the first cover member, and an uneven element may be formed in the third cover member.

According to an embodiment, a heat dissipation hole configured to penetrate a portion of a center of the first cover member may be formed in the first cover member so that heat of the caliper body is dissipated.

According to an embodiment, the cover body may be formed of an aluminum material having a high heat release rate, and heat of the caliper body may be heat-conducted to the cover body by the coupling element to be cooled down.

According to an embodiment, a dust collecting member formed of a filter material may be attached to an inner surface of the cover body, and the dust collecting member may be configured to collect dust of the brake pad.

According to an embodiment, the cover body may be fixed to the caliper body by the coupling portion and the cover body and the caliper body may be slidingly moved with the same displacement.

Another embodiment is an electromechanical brake system, including: a disk rotor configured to rotate on an inside of a wheel; a brake pad configured to compress both side surfaces of the disk rotor to brake; a caliper assembly disposed between the disk rotor and the wheel and having a caliper body configured to accommodate the brake pad therein and a torque member; an electric-type power unit configured to operate the caliper assembly with electric power; a cover body configured to cover and protect an external appearance of the caliper assembly; and a coupling portion configured to couple the cover body to the caliper body, and the cover body may include: a first cover member formed to cover an outer circumferential surface of the caliper assembly; a second cover member formed to cover a front surface of the caliper assembly and connected to the first cover member, and a third cover member configured to cover a side surface of the caliper assembly, refracted and extending from both sides of the second cover member, and connected to the first cover member.

According to an embodiment, the cover body may further include: a recess formed recessed from the first cover member to be in contact with a bridge portion of the caliper body and having a through hole; a fixing portion recessed from the first cover member toward a finger portion of the caliper body and coming into close contact with an outer side surface of the finger portion; and a protrusion protruding from the second cover member toward the caliper body and inserted into an insertion groove positioned at a center of the finger portion.

According to an embodiment, the coupling portion may include: a coupling hole dug on the bridge portion; and a coupling element configured to pass through the through hole, seated on the recess and coupled to the coupling hole, and each of the recess and the coupling portion may be provided one or more in number, and a guide configured to guide the coupling element and formed to be communicated with the coupling hole may be configured in the bridge portion.

According to an embodiment, a heat dissipation hole configured to penetrate a portion of a center of the first cover member may be formed in the first cover member so that heat of the caliper body is dissipated, the cover body may be formed of an aluminum material having a high heat release rate, and heat of the caliper body may be heat-conducted to the cover body by the coupling element to be cooled down.

According to an embodiment, a dust collecting member formed of a filter material may be attached to an inner surface of the cover body, and the dust collecting member may be configured to collect dust of the brake pad.

According to the present disclosure, it is possible to have a unique and differentiated styling effect and protect the caliper assembly by coupling a cover device to the caliper assembly of the electromechanical brake.

In addition, the cover body of the cover device is formed of an aluminum material, and the entire area thereof is exposed to the air, and thus, such a configuration helps in dissipating heat easily. There is a cooling effect as heat is conducted to the cover body through the coupling portion.

Moreover, the cover body is easily attached to or detached from the caliper assembly by the coupling portion, and vibration of the cover body because of an external force may be reduced as the cover body comes into close contact with the caliper body by the fixing portion and the protrusion.

The effects of the present disclosure are not limited to the above effects, and should be understood to include all effects that can be deduced from the configuration described in the detailed description or claims of the present disclosure.

### BRIEF DESCRIPTION OF THE DRAWINGS

FIG. 1 is a front view illustrating a structure in which an electromechanical brake system with a cover device according to an embodiment is disposed on an inside of a wheel.

FIG. 2 is a perspective view in which elements of a cover device according to an embedment of the present disclosure are coupled to one another.

FIG. 3 is an exploded perspective view of a cover device in FIG. 2.

FIG. 4 is a perspective view of an outside of a cover body according to an embodiment of the present disclosure.

FIG. 5 is a perspective view of an inside of a cover body according to an embodiment of the present disclosure.

FIG. 6 is a perspective view illustrating a caliper assembly to which a cover body and a coupling portion according to an embodiment are coupled.

FIG. 7 is a right side view of a cover device according to an embodiment of the present disclosure.

FIG. 8 is a bottom view of a cover device according to an embodiment of the present disclosure.

FIG. 9 is a rear perspective view according to an embodiment of the present disclosure.

### DETAILED DESCRIPTION

Hereinafter, a cover device and an electromechanical brake system including the same according to exemplary embodiments will be described with reference to the accompanying drawings.

In addition, the terms as used herein are terms defined in consideration of functions of the disclosure and may change depending on the intention or practice of a user or an operator. The following embodiments are not intended to limit the scope of the disclosure but are merely illustrative of the components set forth in the appended claims.

For clear explanation of the disclosure, parts irrelevant to the description may be omitted in the drawings, and like reference numerals refer to like or similar parts throughout the specification. In the whole specification, it will be understood that when a component is referred to as “comprising” or “including” any component, it does not exclude other components, but can further comprise or include the other components unless otherwise specified.

In the disclosure, an element referred to as a “unit” may represent two or more elements integrated into one or one element divided into multiple elements according to subdivided functions. In addition, each element described later may perform some or all functions of another element in addition to its main functions, and some main functions of each element may be entirely performed by another element.

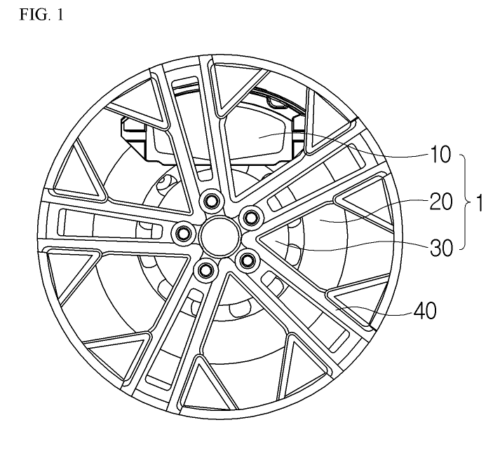

First, a cover device 10 and an electromechanical brake system including the same according to a first embodiment of the disclosure will be described with reference to FIGS. 1-9. The cover device 10 may be positioned between a disk rotor 20 and a wheel 40, and may be formed to cover a caliper assembly 300. The cover device 10 may be formed in a shape not being interfered by the wheel 40 and a hub 30. The cover device 10 may be mounted in an electromechanical brake system and has a unique and differentiated external appearance.

The cover device 10 may include a cover body 100 and a coupling portion 200. The cover body 100 may be formed to cover and protect an external appearance of the caliper assembly 300. The coupling portion 200 may couple the cover body 100 to a caliper body 301 so that the caliper body 301 and the cover body 100 can be integrated into each other.

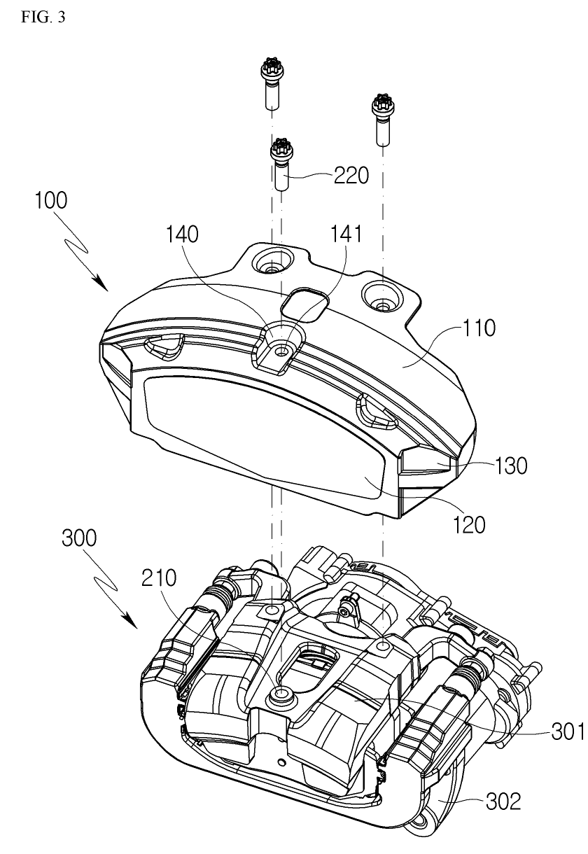

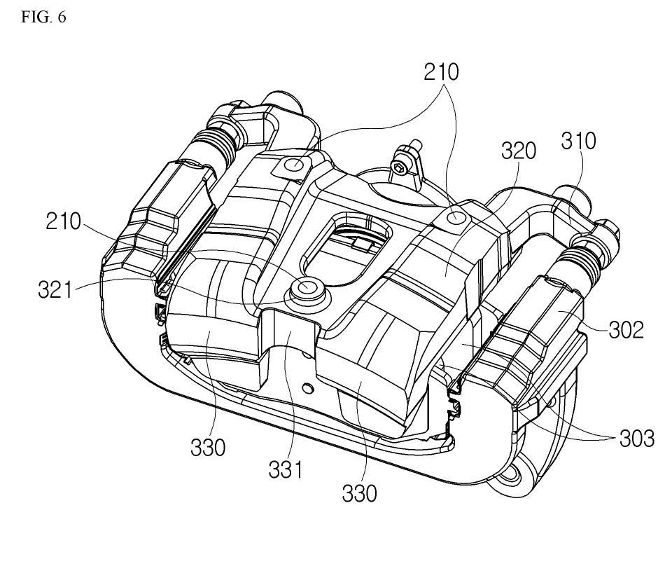

As illustrated in FIGS. 3 and 6, the caliper assembly 300 may consist of the caliper body 301, a torque member 302, and a brake pad 303. The brake pad 303 may be accommodated between the caliper body 301 and the torque member 302. The caliper body 301 and the torque member 302 are moved in each different direction and the brake pads 303 facing each other get closer to each other and compress the disk rotor 20, thereby braking is performed.

The caliper body 301 may consist of a pin attaching portion 310, a bridge portion 320, and a finger portion 330. The pin attaching portion 310 may be directly connected to the torque member 302, and the bridge portion 320 may extend forward from the pint attaching portion 310 while passing by the torque member 302. The finger portion 330 may extend from the bridge portion 320 while forming an angle.

Again, referring to FIGS. 1-9, the cover body 100 may include a first cover member 110, a second cover member 120, and a third cover member 130. In some cases, the cover body 100 may consist of the first cover member 110 and the second cover member 120, or the cover body 100 may consist of the first cover member 110, the second cover member 120 and the third cover member 130.

The first cover member 110 may be formed to cover an outer circumferential surface of the caliper assembly 300. In FIG. 3, the first cover member 110 is formed such that the first cover member 110 covers an upper outer circumferential surface of the caliper assembly 300. The first cover member 110 is formed as a plate in an arc shape. The first cover member 110 is spaced apart from the wheel 40 so that it is not interfered by the wheel 30, and may be parallel to an inside of the wheel 40.

In more detail, a width of the first cover member 110 may gradually be narrowed rearward at both tip ends, and the width thereof may bulge at a center. In other words, a tapered portion may be formed at the both tip ends toward a rear, and a bulging portion extending rearward from the tapered portion may be formed. Both tip ends of the bulging portion may be formed perpendicular, and an outer center portion of the bulging portion may be dug forward.

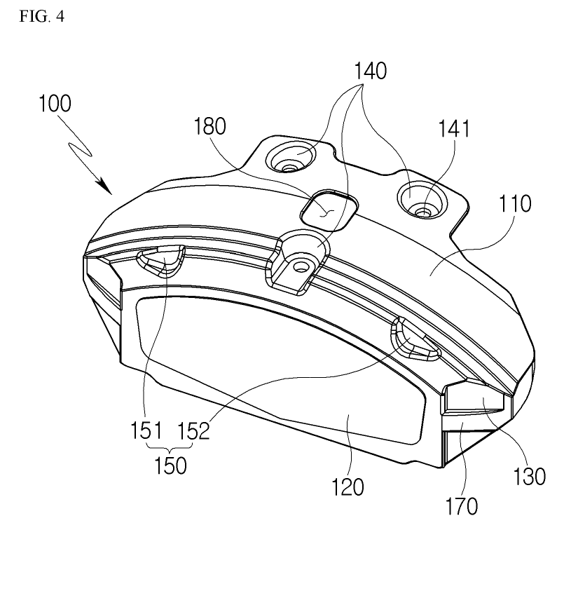

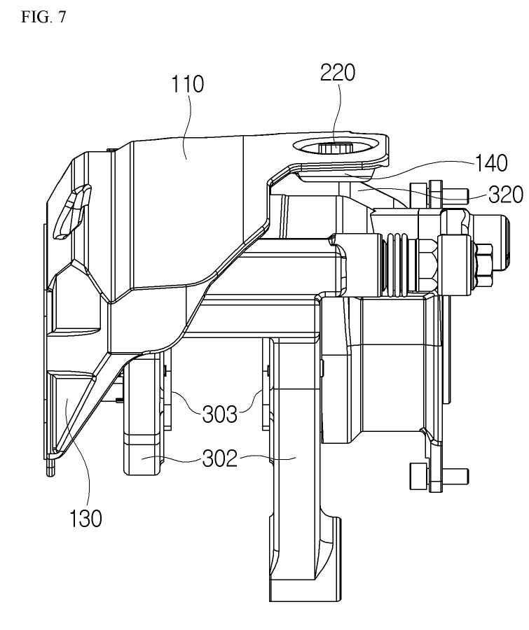

At a front surface portion of the first cover member 110, a step in an arc shape may be formed. As illustrated in FIGS. 4 and 7, a stepped portion which is lowered may be formed at a front side of the first cover member 110. The stepped portion may be formed at a portion at which the first cover member 110 and the second cover member 120 are connected. The stepped portion may consist of a first step and a second step. The first step may be formed lowered forward from a flat portion of the first cover member 110. The second step may be formed lowered forward from the first step and be connected to the second cover member 120.

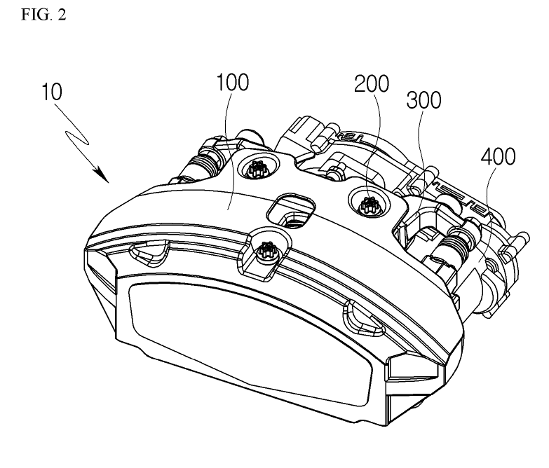

In addition, in the first cover member 110, a heat dissipation hole 180 is formed so as to dissipate heat of the caliper body 301 generated at the time of braking. The heat dissipation hole 180 may penetrate a portion of a center of the first cover member 110. The heat dissipation hole 180 may be formed in a quadrangular shape with a rounded edge. As illustrated in FIGS. 2-4, the heat dissipation hole 180 may be formed at a close interval to a center hole of the bridge portion 320. The heat dissipation hole 180 may be formed as at least one or more holes in the first cover member 110.

The second cover member 120 may be formed to cover a front surface which is a front side of the caliper assembly 300 and may be connected to the first cover member 110. The second cover member 120 may be formed angular downward of the first cover member 110, and at this instance, the angle may be a right angle. The second cover member 120 may be formed as a flat plate, and a brand name may be coated or imprinted on a surface thereof.

The third cover member 130 may cover a side surface of the caliper assembly 300, may be refracted and extend from both sides of the second cover member 120, and may be connected to the first cover member 110. In more detail, one portion of the third cover member 130 may extend angular from both tip ends of the second cover member and another portion thereof may extend angular from the one portion to be connected to the tapered portion.

In the third cover member 130, an uneven element 170 may be formed so as to maintain required strength of the cover body 100 and reduce a weight of the cover body 100. The uneven element 170 may be formed to start from a center portion of the both tip ends of the second cover member 120, be bent perpendicularly and connected to the first step, and this portion may protrude as a single layer. The uneven element 170 may be formed only on an outer surface of the third cover member 130, and an inner surface of the third cover member 130 may be flat.

The first cover member 110, the second cover member 120, and the third cover member 130 of the cover body 100 may be formed integrally, and the cover body 100 may be formed to maintain required strength and have a reduced weight through an optimized design. The cover body 100 may reduce a volume and a weight compared to the conventional cover, thereby the mechanical performance may be improved.

In addition, as the cover body 100 is manufactured of an aluminum material having a high heat release rate, and the entire area thereof is exposed to the air, heat dissipation of the cover body 100 is easy. In addition, as the cover body 100 is manufactured of an aluminum material, forming the cover body 100 through diecasting is easy.

The cover body 100 may further include a recess 140, a fixing portion 150, and a protrusion 160. The recess 140 and the fixing portion 150 are formed in the first cover member 110, and the protrusion 160 is formed in the second cover member 120.

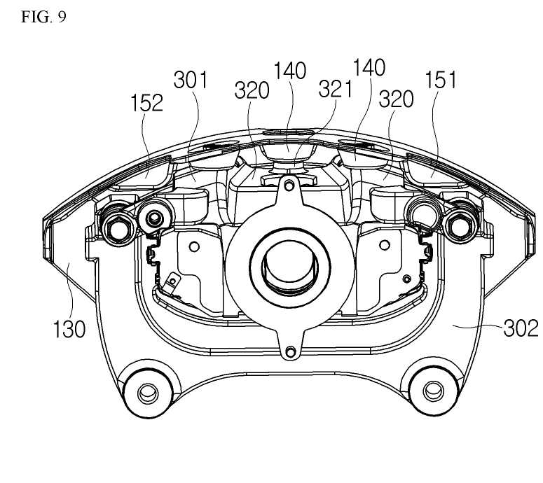

As illustrated in FIGS. 4 and 9, the recess 140 may be recessed in the first cover member 110 such that it contacts the bridge portion 320 of the caliper body 301. The recess 140 may have a through hole 141 in a hole shape so as to fasten the cover body 100 to the caliper body 301. As an area of the recess in contact with the caliper body 301 is wide, the cover body 100 may come into close contact with the first cover member 110, thereby fixability may increase.

In more detail, the recess 140 may be formed symmetrical to both sides of the bulging portion of the first cover member 110. The recess 140 may be formed in a bowl shape retracted downward and a flat bottom surface is formed on its bottom surface. The through hole 141 in a hole shape may be formed on the bottom surface.

The recess 140 is formed recessed across the stepped portion of the first cover member 110. The recess 140 of the stepped portion may be dug such that a rear side thereof is rounded and a front side thereof is opened, and may be retracted such that surfaces thereof are brought closer to each other. A flat bottom surface is formed at a bottom of the recess 140 of the stepped portion. On the bottom surface, the through hole 141 in a form of a hole is formed.

As illustrated in FIGS. 3 and 6, the coupling portion 200 may include a coupling hole 210 and a coupling element 220. The coupling hole 210 may be formed to be dug in the bridge portion 320. The dug portion may be formed in an elongated cylindrical shape. A thread may be formed on an internal surface of the coupling hole 210.

The coupling element 220 may be provided as a torx bolt. In other words, the coupling element 220 may have be formed as a bolt consisting of a thread at its lower portion, a stopper at a center portion, and a star-shaped head at its upper portion. The coupling element 220 may pass through the through hole 141, and be coupled to the coupling hole 210 while being seated on the recess 140.

Both sides of the bridge portion 320 close to the torque member 302 may secure high strength and the coupling hole 210 may be disposed on both upper sides of the bridge portion 320. At the same time, on a front side of the bridge portion 320 close to the finger portion 330, the coupling hole 210 may be disposed. Accordingly, total of three coupling holes 210 may be disposed in a triangular shape, and total of three recesses 140 may be disposed in a triangular shape in correspondence with the three coupling holes 210. In some cases, each of the recess 140 and the coupling portion 200 may be configured one or more in number.

Because of the above-described configuration, the recess 140 may be inserted between the coupling hole 210 and the coupling element 220 so that the cover body 100 may be fixed to the caliper body 301. The coupling element 220 may be attached to or detached from the coupling hole 210, and thus, the cover body 100 may be easily coupled or decoupled to/from the caliper body 301. In addition, as the cover body 100 is fixed to the caliper body 301 by the coupling portion 200, the cover body 100 and the caliper body 301 may be slidingly moved simultaneously with the same displacement.

In a state in which the cover body 100 is coupled to the caliper body 301, heat generated in the brake pad 303 at the time of braking may be transferred to the caliper body 301, and the heat in the caliper body 301 may be heat-conducted to the cover body 100 through the coupling element 220, thereby the heat can be cooled down. The entire area of the cover body 100 may be exposed to the air and therefore, heat can be easily cooled down.

A guide 321 may be formed in the bridge portion 320 such that it can guide the coupling element 220 and be communicated with the coupling hole 210. As illustrated in FIGS. 6 and 9, the guide 321 may be formed in an annular shape with a flat upper portion so that the guide 321 can meet the recess 140 formed in the stepped portion of the first cover member 110. In order to bring the recess 140 to come into close contact with the bridge portion 320, the guide 321 may be formed in the bridge portion 320 while filling in a gap between the recess 140 and the bridge portion 320.

Referring to FIGS. 4-9, the fixing portion 150 may be formed to be recessed toward the finger portion 330 of the caliper body 301 from the first cover member 110. The fixing portion 150 may have a first fixing element 151 and a second fixing element 152. The first fixing element 151 and the second fixing element 152 may be formed to be axisymmetrical, and may come into close contact with an outer side surface of the finger portion 330.

The first fixing element 151 may be recessed in a shape of a right-angled triangle with a rounded edge. The second fixing element 152 may be recessed in axisymmetry with respect to the first fixing element 151. A perpendicular area of the first and second fixing elements 151 and 152 comes into close contact with an outer side surface of the finger portion 330, thereby the cover body 100 is fixed to the caliper body 301.

The protrusion 160 may protrude toward the caliper body 301 from the second cover member 120. The protrusion 160 may be formed with a single body or a plurality of bodies. The finger portion 330 may have an insertion groove 331 dug toward the guide 321 at a center thereof. With this configuration, the protrusion 160 may be inserted into the insertion groove 331 positioned at a center of the finger portion 330.

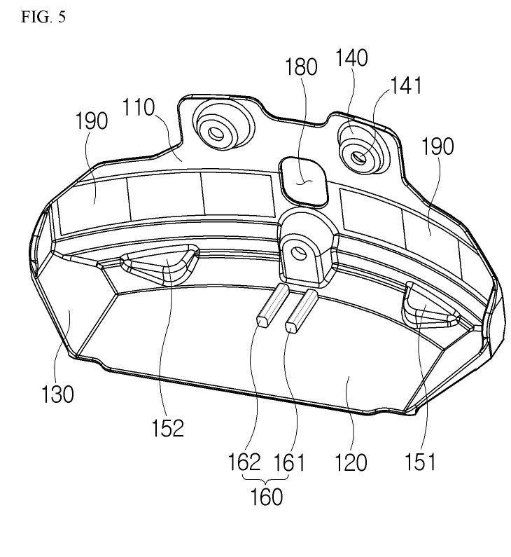

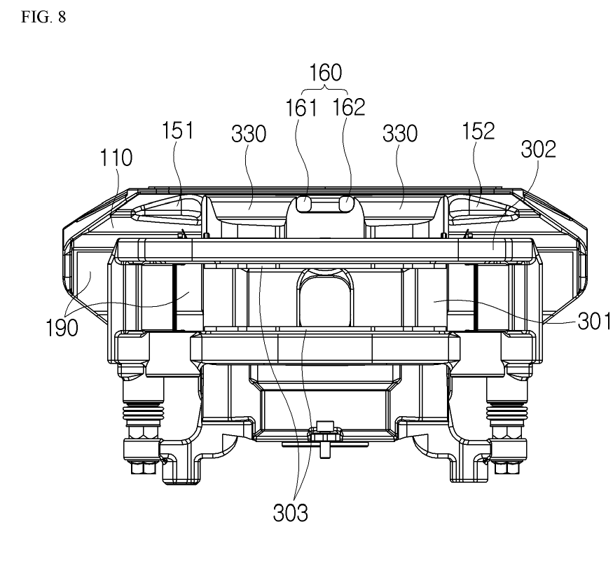

As illustrated in FIGS. 5 and 8, the protrusion 160 may consist of a first protrusion element 161 and a second protrusion element 162. Each of the first protrusion element 161 and the second protrusion element 162 may be formed in a quadrangular column shape with a rounded edge. The first protrusion element 161 and the second protrusion element 162 may be disposed to be symmetrical with each other. A circumferential surface of the first protrusion element 161 and the second protrusion element 162 may come into close contact with the insertion groove 331 between the finger portions 330 and be inserted into the insertion groove 331.

With this configuration, the fixing portion 150 and the protrusion 160 may fix the cover body 100 to the caliper body 301, thereby a movement of the cover body 100 because of an external vibration can be reduced. In other words, the fixing portion 150 may bring the first cover member 110 into close contact with the caliper body 301, and the protrusion 160 may bring the second cover member 120 into close contact with the caliper body 301. Therefore, the vibration of the cover body 100 because of external vibration outside the cover device 10 may be diminished and the vibration performance of the cover body 100 may be improved by the fixing portion 150 and the protrusion 160.

Referring to FIGS. 5 and 8, a dust collecting member 190 formed of a filter material may be attached to an inner surface of the cover body 100. The dust collecting member 190 may collect dust in the disk rotor 20 and the brake pad 303 generated at the time of braking. In FIG. 5, the dust collecting member 190 attached to the first cover member 110, which is the closest to the friction surface of the brake pad 303, is illustrated, however, the dust collecting member 190 may be attached to both the second cover member 120 and the third cover member 130 as well. With this configuration, the braking dust may be reduced and laws and regulations for reducing braking dust of each nation may be satisfied.

Next, in the following description, description on the configuration redundant with the configuration of the cover device 10 according to an embodiment of the present disclosure which has been described above will be omitted. The configuration of the cover device 10 may be included in an electromechanical brake system 1. Referring to FIGS. 1-9 again, the electromechanical brake system 1 according to another embodiment of the present disclosure will be described.

The electromechanical brake system 1 may include the disk rotor 20, the brake pad 303, the caliper assembly 300, an electric-type power unit 400, the cover body 100, and the coupling portion 200. The electromechanical brake system 1 may be applied to various transportation means as well as braking of the automobile.

The wheel 40 may be coupled to the disk rotor 20 by the hub 30, and the wheel 40 and the disk rotor 20 may rotate at the same angular speed. The disk rotor 20 may be positioned on an inside of the wheel 40 and may rotate therein.

The brake pad 303 may compress both sides of the disk rotor 20 to brake. The caliper assembly 300 may be disposed between the disk rotor 20 and the wheel 40, and may have the caliper body 301 accommodating the brake pad 303 and the torque member 302.

As illustrated in FIGS. 3 and 6, the caliper body 301 may consist of the pin attaching portion 310, the bridge portion 320, and the finger portion 330. The pin attaching portion 310 may be directly connected to the torque member 302, and the bridge portion 320 may extend forward from the pin attaching portion 310 while passing by the torque member 302.

The bridge portion 320 and the finger portion 330 may be positioned while being spaced apart from the torque member 302, and may not contact each other even when they are operated. At a center of the bridge portion 320, a center hole may be positioned so that heat generated at the time of braking may be released.

The finger portion 330 may extend while forming an angle from the bridge portion 320. Two elements of the finger portion 330 are formed symmetrical with each other, and the finger portion 330 may have the insertion groove 331 dug toward the guide 321 at an upper center of the two elements. The insertion groove 331 may be formed dug rearward from the center of the finger portion 330, and the dug surface may be formed flat. With this configuration, the protrusion 160 may be inserted into the insertion groove 331.

The guide 321 may be formed in the bridge portion 320 so as to guide the coupling element 220, and be communicated with the coupling hole 210. As illustrated in FIGS. 6 and 9, the guide 321 may have an annular shape with a flat upper portion so that the guide 321 meets the recess formed in the stepped portion of the first cover member 110. The guide 321 may be formed in the bridge portion 320 while filling in a gap between the recess 140 and the bridge portion 320 so as to bring the recess 140 and the bridge portion 320 into close contact with each other.

The electric-type power unit 400 may operate the caliper assembly 300 with electric power. A motor of the electric-type power unit 400 rotates so that the caliper body 301 and the torque member 302 are moved in each different direction in the same axis. At this instance, the brake pads 303 facing each other get close to each other and compress the disk rotor 20 to brake.

The cover body 100 may be formed to cover and protect an external appearance of the caliper assembly 300. The coupling portion 200 may couple the cover body 100 to the caliper body 301. The cover body 100 includes the first cover member 110, the second cover member 120, and the third cover member 130. In addition, the cover body 100 may further include the recess 140, the fixing portion 150, and the protrusion 160. The coupling portion 200 may include the coupling hole 210 and the coupling element 220.

With this configuration, by coupling the cover device 10 to the caliper assembly 300 of the electromechanical brake, it is possible to protect the caliper assembly 300 while having an effect of unique and differentiated external appearance styling.

In addition, the cover body 100 of the cover device 10 may be manufactured of an aluminum material, and the entire area thereof is exposed to the air, thus, heat dissipation is made easy. The heat can be conducted to the cover body 100 through the coupling portion 100 and can be cooled down.

Furthermore, the cover body 100 may be easily attached to or detached from the caliper assembly 300 by the coupling portion 200, and the cover body 100 may be brought into close contact with the caliper body 301 by the fixing portion 150 and the protrusion 160, thereby reducing vibration of the cover body 100 because of the external force.

The present disclosure is not limited to the above-described specific embodiments and descriptions, and various modifications may be made by those skilled in the art without departing from the gist of the present disclosure claimed in the claims. Such variations are within the protection scope of the present disclosure.

What is claimed is:

1. A cover device, comprising:
a cover body configured to cover and protect an external appearance of a caliper assembly; and
a coupling portion configured to couple the cover body to a caliper body,
wherein the cover body comprises:
a first cover member configured to cover an outer circumferential surface of the caliper assembly; and
a second cover member configured to cover a front surface of the caliper assembly and connected to the first cover member, and
wherein the cover device is mounted in an electromechanical brake system.

2. The cover device of claim 1,
wherein the cover body further comprises:
a recess recessed from the first cover member to be in contact with a bridge portion of the caliper body and having a through hole;
a fixing portion recessed from the first cover member toward a finger portion of the caliper body and coming into close contact with an outer side surface of the finger portion; and
a protrusion protruding from the second cover member toward the caliper body and inserted into an insertion groove positioned at a center of the finger portion.

3. The cover device of claim 2,
wherein the coupling portion comprises:
a coupling hole dug on the bridge portion; and
a coupling element configured to pass through the through hole, seated on the recess and coupled to the coupling hole, and
wherein each of the recess and the coupling portion is provided one or more in number, and
wherein the recess is inserted between the coupling hole and the coupling element so that the cover body is fixed to the caliper body.

4. The cover device of claim 3,
wherein a guide configured to guide the coupling element and communicated with the coupling hole is configured in the bridge portion.

5. The cover device of claim 2,
wherein the fixing portion and the protrusion are configured to fix the cover body to the caliper body so that a movement of the cover body by external vibration is reduced.

6. The cover device of claim 1,
wherein the cover body further comprises:
a third cover member configured to cover a side surface of the caliper assembly, refracted and extending from both sides of the second cover member, and connected to the first cover member, and
wherein an uneven element is formed in the third cover member.

7. The cover device of claim 1,
wherein a heat dissipation hole configured to penetrate a portion of a center of the first cover member is formed in the first cover member so that heat of the caliper body is dissipated.

8. The cover device of claim 3,
wherein the cover body is formed of an aluminum material having a high heat release rate, and
wherein the coupling element is configured to conduct heat from the caliper body is conducted to the cover body.

9. The cover device of claim 1,
wherein a dust collecting member formed of a filter material is attached to an inner surface of the cover body, and
wherein the dust collecting member is configured to collect dust of a brake pad.

10. The cover device of claim 1,
wherein the cover body is fixed to the caliper body by the coupling portion and the cover body and the caliper body are slidingly moved with a same displacement.

11. An electromechanical brake system, comprising:
a disk rotor configured to rotate on an inside of a wheel;
a brake pad configured to compress both side surfaces of the disk rotor to brake;
a caliper assembly disposed between the disk rotor and the wheel and having a caliper body configured to accommodate the brake pad therein and a torque member;
an electric-type power unit configured to operate the caliper assembly with electric power;
a cover body configured to cover and protect an external appearance of the caliper assembly; and
a coupling portion configured to couple the cover body to the caliper body, and
wherein the cover body comprises:
a first cover member configured to cover an outer circumferential surface of the caliper assembly;
a second cover member configured to cover a front surface of the caliper assembly and connected to the first cover member, and
a third cover member configured to cover a side surface of the caliper assembly, refracted and extending from both sides of the second cover member, and connected to the first cover member.

12. The electromechanical brake system of claim 11,
wherein the cover body further comprises:
a recess recessed from the first cover member to be in contact with a bridge portion of the caliper body and having a through hole;
a fixing portion recessed from the first cover member toward a finger portion of the caliper body and coming into close contact with an outer side surface of the finger portion; and
a protrusion protruding from the second cover member toward the caliper body and inserted into an insertion groove positioned at a center of the finger portion.

13. The electromechanical brake system of claim 12,
wherein the coupling portion comprises:
a coupling hole dug on the bridge portion; and
a coupling element configured to pass through the through hole, seated on the recess and coupled to the coupling hole, and
wherein each of the recess and the coupling portion is provided one or more in number, and
wherein a guide configured to guide the coupling element and communicated with the coupling hole is configured in the bridge portion.

14. The electromechanical brake system of claim 13,
wherein a heat dissipation hole configured to penetrate a portion of a center of the first cover member is formed in the first cover member so that heat of the caliper body is dissipated,
wherein the cover body is formed of an aluminum material having a high heat release rate, and
wherein the coupling element is configured to conduct heat from the caliper body is conducted to the cover body.

15. The electromechanical brake system of claim 11,
wherein a dust collecting member formed of a filter material is attached to an inner surface of the cover body, and
wherein the dust collecting member is configured to collect dust of the brake pad.
